(19) United States
(12) Patent Application Publication
(10) Pub. No.: US 2025/0381863 A1
(43) Pub. Date: Dec. 18, 2025

(54) Charging Apparatus

(71) Applicants: Hyundai Motor Company, Seoul (KR); Kia Corporation, Seoul (KR)

(72) Inventors: Yong Chul Shin, Hwaseong-Si (KR); Youn Lee, Hwaseong-Si (KR); Byung Ho Yoon, Hwaseong-Si (KR); Ki Hoon Nam, Hwaseong-Si (KR)

(21) Appl. No.: 18/952,411

(22) Filed: Nov. 19, 2024

(30) Foreign Application Priority Data
Jun. 17, 2024 (KR) 10-2024-0078311

(51) Int. Cl. B60L 53/16; B60L 53/30

(52) U.S. Cl. CPC B60L 53/16; B60L 53/30

(57) ABSTRACT

A charging apparatus includes a charging part having a docking area (e.g., one or more electrical plugs) configured to dock to a charging hole (e.g., one or more socket/outlet/receptacle), and a charging hole opening/closing part configured to be mounted on the charging part. The charging hole opening/closing part may include a gripper, provided on a first side of the docking area that faces the charging hole, to grip a charging hole cap configured to cover the charging hole, and a gripper connecting member coupled to the gripper, and configured such that the gripper is movable in a direction being more distant from the charging hole than the docking area is to the charging hole.

### CROSS-REFERENCE TO RELATED APPLICATION

This application claims the benefit of priority to Korean Patent Application No. 10-2024-0078311, filed in the Korean Intellectual Property Office on Jun. 17, 2024, the entire contents of which are incorporated herein by reference.

### TECHNICAL FIELD

The present disclosure relates to a charging apparatus.

### BACKGROUND

Research on electric vehicles (and/or hybrid vehicles) is being actively conducted in that they are the most likely alternative to solving automobile pollution and energy problems. Because the electric vehicles generate driving power with an electric motor (e.g., a drive motor) that obtains rotational power through electric energy, batteries that supply electric energy for vehicle operations may be mounted. The batteries installed in the vehicle may have to be charged from time to time to continue driving/powering the vehicle operations.

To charge the electric vehicles (to charge the batteries), a charging hole, and a charging hole cap for protecting the charging hole from being exposed to the outside have to be provided in vehicle bodies of the electric vehicles. Meanwhile, conventionally, to charge the battery, the user has to directly dock a charging part provided in a charging station to a charging hole. After charging is completed, the charging part has to be separated from the charging hole again, which is bothersome and inconvenient to perform manually.

The process of docking the charging part to the charging hole may be performed using a charging robot, but it is difficult to automate and unman the charging process entirely because the mounting or separation of the charging hole cap has to be performed by the manual operation of the user.

### SUMMARY

The following summary presents a simplified summary of certain features. The summary is not an extensive overview and is not intended to identify key or critical elements.

Systems, apparatuses, and methods are described a charging apparatus. A charging apparatus may comprise a charging part comprising one or more electrical plugs configured to dock to one or more charging holes; and a charging hole opening/closing part mounted on the charging part. The charging hole opening/closing part may comprise a gripper configured to: be positioned on a docking side of the one or more electric plugs, wherein the docking side is a side that faces the one or more charging holes when docking; and grip a charging hole cap configured to cover the one or more charging holes; and a gripper connecting member, coupling to the gripper to the charging part, configured to move the gripper from the docking side of the one or more electric plugs to be positioned away from the docking side of the one or more electric plugs.

Also, or alternatively, an automated charging method may comprise: moving a charging part, comprising one or more electric plugs and a gripper, in a docking direction towards one or more charging holes covered by a charging hole cap; gripping, via the gripper, the charging hole cap; separating, by the gripper, the charging hole cap from the one or more charging holes by moving the gripped charging hole cap away from the one or more charging holes; and docking the one or more electric plugs to the one or more charging holes.

Also, or alternatively, A charging apparatus may comprise: a charging part comprising: one or more electrical plugs, facing a docking direction of the charging part, configured to dock to one or more charging holes of a charging target; and a bracket configured to detachably attach to a robotic arm configured to move the charging part; and a charging hole opening/closing part, attached to the charging part, comprising: a gripper configured to grip a charging hole cap configured to cover the one or more charging holes; and a gripper connecting member configured to: movably couple the gripper to the charging part; and move the gripper between a first position in the docking direction relative to the one or more electric plugs and a second position in an opposite direction to the docking direction relative to the one or more electric plugs.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of a charging apparatus according to an example of the present disclosure;

FIG. 2 is a perspective view of a charging part according to an example of the present disclosure;

FIG. 3 is a side view of a charging apparatus according to an example of the present disclosure;

FIG. 4 is a side view of a charging apparatus that is moved toward a charging hole according to an example of the present disclosure;

FIG. 5 is a side view of a charging apparatus that grips a charging hole cap according to an example of the present disclosure;

FIG. 6 is a side view of a charging apparatus that separates a charging hole cap from a charging hole according to an example of the present disclosure;

FIG. 7 is a side view of a charging apparatus that is moved to a charging hole to be docked to a charging hole according to an example of the present disclosure;

FIG. 8 is a perspective view of a charging apparatus according to another example of the present disclosure;

FIG. 9 is a perspective view of a charging apparatus in a state, in which a gripper is moved in a docking direction according to another example of the present disclosure;

FIG. 10 is a perspective view of a charging apparatus according to another example of the present disclosure;

FIG. 11 is a perspective view of a charging apparatus in a state, in which a gripper is moved in a docking direction according to another example of the present disclosure;

FIG. 12 is a side view of a charging apparatus according to another example of the present disclosure;

FIG. 13 is a side view of a charging apparatus according to another example of the present disclosure; and

FIG. 14 is a flowchart of a charging method according to an example of the present disclosure.

### DETAILED DESCRIPTION

Hereinafter, examples of the present disclosure will be described in detail with reference to the accompanying drawings. In adding reference numerals to the components of the drawings, it is noted that the same components are denoted by the same reference numerals even when they are drawn in different drawings. Furthermore, in describing the examples of the present disclosure, when it is determined that a detailed description of related known configurations and functions may hinder understanding of the examples of the present disclosure, a detailed description thereof will be omitted.

Furthermore, in describing the components of the examples of the present disclosure, terms, such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

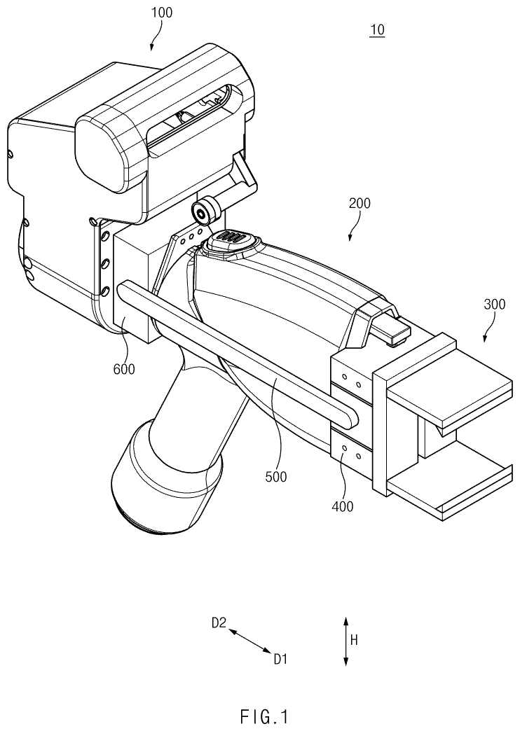

Hereinafter, examples of the present disclosure will be described in detail with reference to FIGS. 1 to 14.

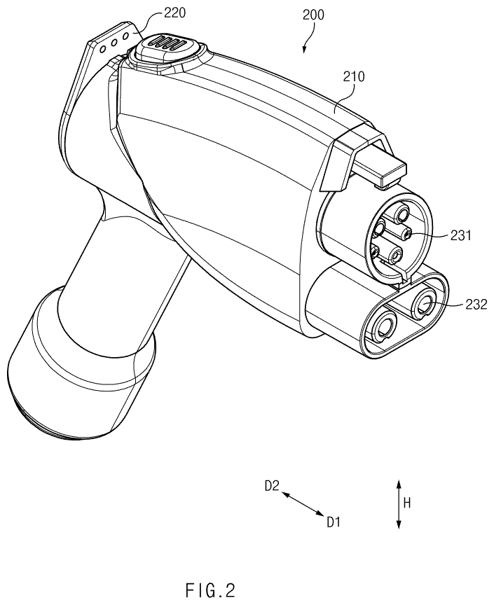

FIG. 1 is a perspective view of a charging apparatus according to an example of the present disclosure. FIG. 2 is a perspective view of a charging part according to an example of the present disclosure.

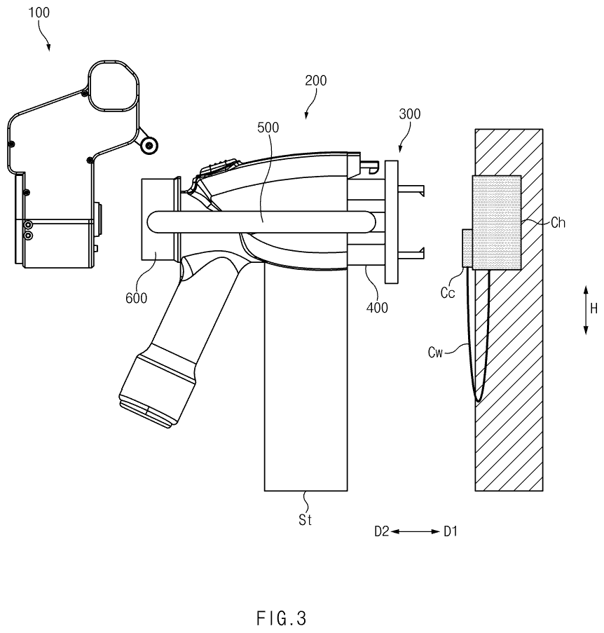

Referring to FIGS. 1 and 2, a charging apparatus 10 according to an example of the present disclosure may supply electric energy to a charging target (e.g., an electric vehicle, a hybrid vehicle, or the like). For example, the charging apparatus 10 may supply electric energy to the charging target in a state in which the charging apparatus 10 is docked in a charging hole (e.g., socket, receptacle, outlet) in a charging housing Ch (see FIG. 3). The charging apparatus 10 may include a charging part 200, and an attachment/detachment part 100 that is detachably provided to the charging part 200. The attachment/detachment part 100 may be part of/connected to a robotic arm or other automated movement device configured to move the charging part 200 as disclosed herein. Also, or alternatively, the charging apparatus may comprise the charging part 200, which may be itself automated to move as disclosed herein. However, by moving the charging part 200 using an attachment/detachment part, the attachment/detachment part 100 may detach from the charging part 200 during charging (when the charging part 200 is stationary, as described herein) and may be available to attach to and move other charging parts 200.

The charging apparatus 10 may be configured for automating charging of an external power consumer/target, such as an electric vehicle, without human intervention. The charging apparatus 10 may be used to charge not only an electric vehicle, but also other devices. In this specification, an electric vehicle may be understood as a concept including not only a general vehicle but also a moving object, such as a purpose built vehicle (PBV), a robot, or other mobility, which requires charging.

The charging part 200 may include a charging body 210 that defines a body of the charging part 200, and a bracket member 220 that is provided on one side of the charging body 210 and is adjacent to the attachment/detachment part 100 (e.g., adjacent to a region configured to attach to/detach from the attachment/detachment part 100).

The charging body 210 may include docking areas 231 and 232 (e.g., plugs, electrical connectors, etc.) that are provided to be docked to the charging hole of the charging housing Ch. The docking areas 231 and 232 may be disposed in (e.g., protrude towards/in) a docking direction D1 of the charging body 210 (a direction in which the charging body 210 is configured to dock with the charging hole). The docking direction D1 may be defined as a direction, in which the docking areas 231 and 232 are docked to the charging hole. For example, the charging hole may be formed in a shape that is opened toward an undocking direction D2 opposite/antiparallel to the docking direction D1 of the charging housing Ch (when docking or undocking). The docking direction D1 may be defined as a direction in which the docking areas 231 and 232 face the charging hole in a state, for example, in which the charging hole is configured to accept the docking areas 231 and 232 to be docked.

The docking areas 231 and 232 may include a first docking area 231 for first (e.g., slow) charging of the charging target, and a second docking area 232 for second (e.g., fast) charging of the charging target.

A charging hole cap Cc (see FIG. 3) may be provided to be able to cover/insert into the charging hole to prevent the charging hole from being exposed to the outside.

The charging apparatus 10 may include a charging hole opening/closing part 300, configured for gripping the charging hole cap Cc to separate or mount the charging hole cap Cc from or on the charging housing Ch. The charging hole opening/closing part 300 may be mounted on the charging part 200.

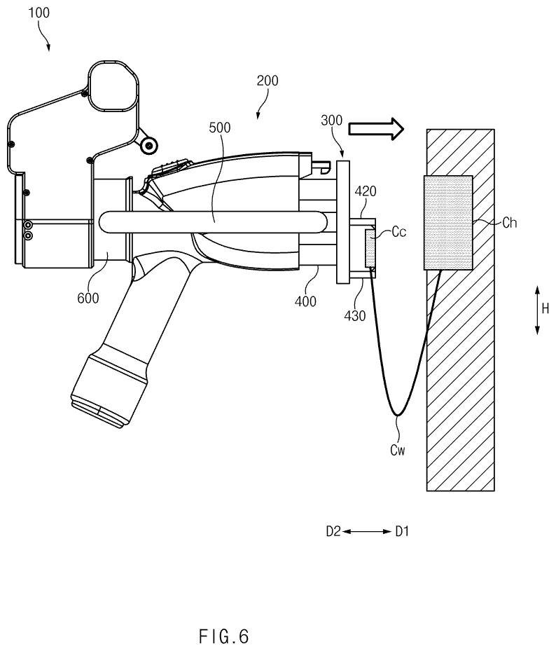

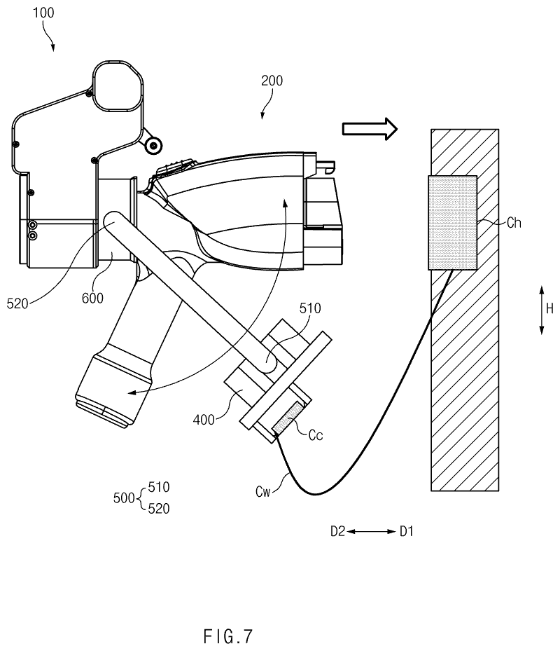

The charging hole opening/closing part 300 may include a gripper 400 that is provided in the docking direction D1 of the docking areas 231 and 232. The gripper 400 may faces the charging hole and be configured to grip the charging hole cap Cc. A gripper connecting member 500 may be coupled to the gripper 400 and configured to move the gripper 400 in a direction that becomes more or less distant from the docking areas 231 and 232 (e.g., may be configured to move the gripper 400 away from the docking areas 231 and 232 as in FIG. 7, or towards/near the docking areas 231 and 232 as in FIG. 6, etc.). A driving module 600 may be configured to move the gripper 400 via the gripper connecting member 500.

The gripper 400 may be provided on a side of the docking areas 231 and 232 in the D1 direction (e.g., a side that faces the charging hole when docking/docked. The driving module 600 may be provided between the charging part 200 and the attachment/detachment part 100, and/or may be closely attached to the bracket member 220 (e.g., a bracket or other structure configured to detachably attach to the attachment/detachment part 100).

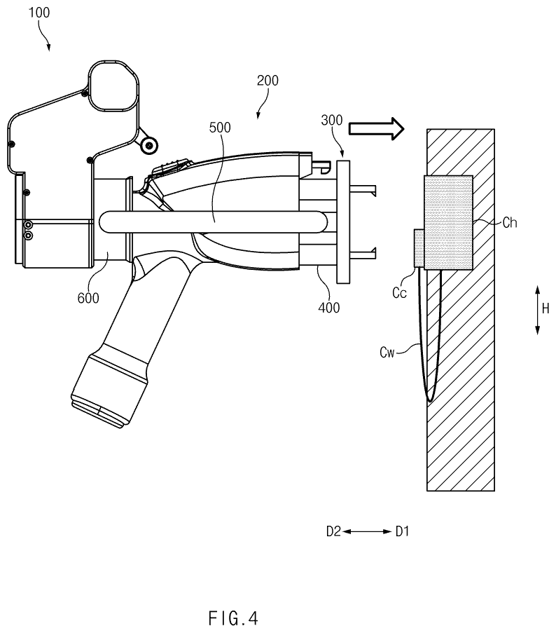

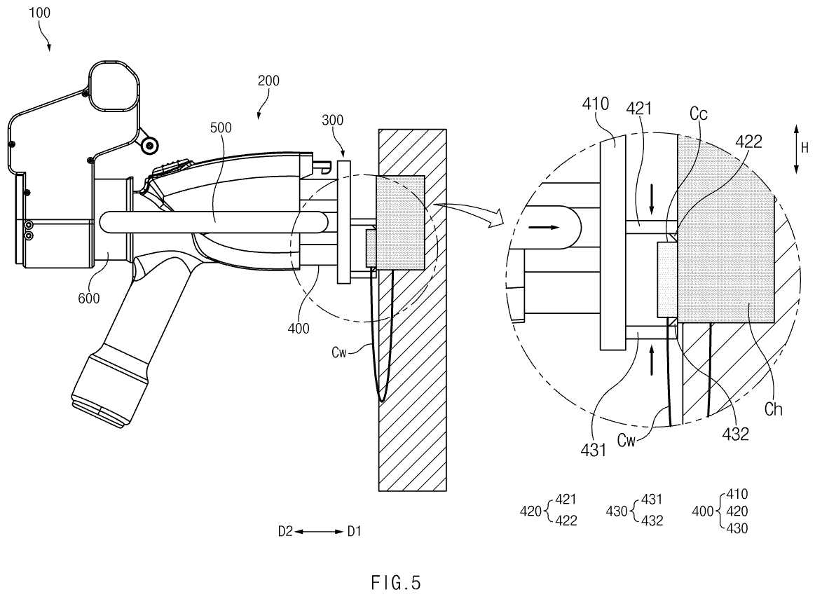

FIG. 3 is a side view of a charging apparatus according to an example of the present disclosure. FIG. 4 is a side view of a charging apparatus that is moved toward a charging hole according to an example of the present disclosure. FIG. 5 is a side view of a charging apparatus that grips a charging hole cap according to an example of the present disclosure. FIG. 6 is a side view of a charging apparatus that separates a charging hole cap from a charging hole according to an example of the present disclosure. FIG. 7 is a side view of a charging apparatus that is moved to a charging hole to be docked to a charging hole according to an example of the present disclosure.

Referring to FIGS. 3 to 7, a principle of the charging part 200 being moved to the charging hole cap Cc to grip the charging hole cap Cc and charging the charging target while the charging part 200 is attached to the attachment/detachment part 100 will be described in detail.

As illustrated in FIG. 3, when the attachment/detachment part 100 is detached from (e.g., before the attachment/detachment part 100 is attached to) the charging part 200, the charging part 200 may be held on/by a holder St. The attachment/detachment part 100 may be moved in the docking direction D1 toward the charging part 200, and the attachment/detachment part 100 may be attached to the driving module 600.

As illustrated in FIG. 4, if the attachment/detachment part 100 is attached to the driving module 600, the charging part 200 may be moved toward the charging housing Ch together with the attachment/detachment part 100. The charging part 200 may be attached to the attachment/detachment part 100 and/or may be moved toward the charging housing Ch to a position corresponding to a height of the charging housing Ch in an upward/downward direction “H”.

The charging hole may be a charging hole configured accept to at least one of the first and second docking areas 231 and 232 (e.g., docked thereinto). The charging hole may be provided as a charging hole (e.g., socket, receptacle, outlet) configured to accept both of the first docking area 231 and the second docking area 232.

The charging hole cap Cc may be configured to cover/block/plug the charging hole, to which docking the first docking area 231 and/or the second docking area 232 is to be docked. The charging hole cap Cc may be configured to cover an area that is docked to the second docking area 232, among the charging holes. The charging hole cap Cc may be connected to the charging housing Ch via a cap wire Cw. The cap wire Cw may be configured to connect to the charging hole cap Cc and the charging housing Ch to prevent loss of the charging hole cap Cc.

Herein, the charging hole cap Cc is discussed in an illustrative example in which it covers a charging hole, among the charging holes, to which the second docking area 232 (see FIG. 2) is configured to dock, and the principle of fast charging by the charging apparatus 10 (see FIG. 1) will be described, but the present disclosure is not limited thereto. For example, the charging hole cap Cc may also or alternatively be configured to cover one or more charging holes, among the charging holes, to which the first docking area 231 is configured to dock, and may also be understood as the principle of slow charging by the charging apparatus 10.

As illustrated in FIG. 5, when the charging part 200 approaches the charging housing Ch, an area of the charging hole, which is to be docked to the second docking area 232, needs to be opened. To this end, the gripper 400 may grip the charging hole cap Cc such that the charging hole cap Cc becomes more distant from (e.g., is moved away from) the charging hole.

The gripper 400 may include a supporting body 410 that is connected to the gripper connecting member 500, and grip fingers 420 and 430 that protrude from the supporting body 410 in an extension direction of the gripper connecting member 500 and grip the charging hole cap Cc in the docking direction D1 side of the docking areas 231 and 232.

The grip fingers 420 and 430 may include a first grip finger 420 and a second grip finger 430. The grip fingers 420 and 430 may be configured to be movable in a first direction towards each other, in which they become closer to each other, and/or a second direction away from each other, in which they become more distant from each other.

The first grip finger 420 may include a first connection area 421 (alternately referred to as a first connection portion) that protrudes from the supporting body 410, and a first grip area 422 (alternately referred to as a first gripping portion) that protrudes from one end of the first connection area 421 toward the second grip finger 430.

The second grip finger 430 may include a second connection area 431 (alternately referred to as a second connection portion) that protrudes from the supporting body 410, and a second grip area 432 (alternately referred to as a second gripping portion) that protrudes from one end of the second connection area 431 toward the first grip area 422 of the first grip finger 420.

A spacing distance between the first grip finger 420 and the second grip finger 430 may be adjusted so that the first grip finger 420 and the second grip finger 430 provided in various sizes may grip the charging hole cap Cc.

When the first and second grip fingers 420 and 430 grip/are gripping the charging hole cap Cc as described herein, the charging part 200 and the charging hole opening/closing part 300 may move away from (e.g., become more distant from) the charging housing Ch, as illustrated in FIG. 6. The gripper 400 may move away from (e.g., become more distant from) the charging housing Ch while gripping the charging hole cap Cc in the docking direction D1 of the charging part 200 (e.g., remove the charging hole cap Cc).

Thereafter, as illustrated in FIG. 7, the gripper 400 may be separated from (move/rotate away from) the docking areas 231 and 232 by the gripper connecting member 500. the gripper 400 may be moved/rotated in a direction away from (e.g., that becomes more distant from) the docking areas 231 and 232.

The gripper 400 may be rotated by the gripper connecting member 500. The gripper connecting member 500 may include an end 510 (a first end) that is connected to the gripper 400 and an opposite end 520 (a second end) connected to the driving module 600. The gripper connecting member 500 may be rotated about the opposite end 520 by the driving module 600.

The one end 510 of the gripper connecting member 500 may be rotated about a rotation axis that extends in a direction that crosses/is perpendicular to the docking direction D1. The one end 510 of the gripper connecting member 500 may be rotated about the axis through/formed by the opposite end 520 of the gripper connecting member 500, which is fixed to the driving module 600.

If the docking direction D1 is a forward direction, the one end 510 of the gripper connecting member 500 may be rotated about a rotation axis that extends in a leftward/rightward direction from the opposite end 520 of the gripper connecting member 500.

If the one end 510 of the gripper connecting member 500 rotates clockwise, the gripper 400 may move away from the docking areas 231 and 232 of the charging part 200 while holding the charging hole cap Cc. The rotating may result in the gripper 400 and the charging hole cap Cc may be located in the opposite direction D2 of the docking direction than/relative to the docking areas 231 and 232.

The gripper connecting member 500 may be rotated by the driving module 600. The driving module 600 may be configured to rotate the gripper connecting member 500, and/or may be located in the undocking direction D2 of the charging part 200.

A driving motor (not illustrated) that may rotate the gripper connecting member 500, a connection shaft (not illustrated) that connects the driving motor and the opposite end of the gripper connecting member 500, and a stopper (not illustrated) for preventing the connection shaft or the gripper connecting member from being rotated by a specific angle or more may be provided in an interior of the driving module 600.

As an example, a stopper may be provided on the connection shaft to interfere with the gripper connecting member 500, and/or may be provided adjacent to the connection shaft to interfere with the connection shaft. Due to this structure (e.g., a stopper as described, the connection shaft and/or the gripper connecting member 500 may be restricted from deviating from a specific rotation range.

Due to this structure, the gripper connecting member 500 may be prevented from being rotated by a specific angle or more (e.g., in a clockwise or counterclockwise direction).

If the one end 510 of the gripper connecting member 500 is rotated in the clockwise direction by the driving module 600, such that the gripper 400 is located in the undocking direction D2 relative to the docking areas 231 and 232, the charging part 200 may be moved in the docking direction D1 toward the charging housing Ch. The docking areas 231 and 232 may be electrically connected to the charging hole(s) so that the charging target may be charged via the charging part 200.

The charging part 200 is charging the charging target, the attachment/detachment part 100 may be detached from the charging part 200 and may be moved to be attached to another charging part 200 to charge another charging target. In other words, according to this structure, a plurality of charging targets may be charged by a plurality of charging parts 200, respectively.

If/after (e.g., based on) charging of the charging target is completed, the charging part 200 may be attached to the attachment/detachment part 100 and may be moved in the undocking direction D2. Thereafter, the one end 510 of the gripper connecting member 500 may be rotated counterclockwise by the driving module 600. The gripper 400 may be rotated counterclockwise by the gripper connecting member 500 while gripping the charging hole cap Cc. Then, the gripper 400 may be rotated again to be positioned in the docking direction D1 of the docking areas 231 and 232.

Thereafter, the charging part 200 may be moved in the docking direction D1 together with the gripper 400. The gripper 400 may move the charging hole cap Cc so that the charging hole cap Cc is mounted on the charging housing Ch. Then, the charging hole cap Cc may close an area of the charging hole, in which the second docking area 232 is configured to be docked.

The charging apparatus 10 (see FIG. 1) may grip the charging hole cap Cc provided in the charging housing Ch, remove the charging hole cap Cc and move it out of the way such that the docking areas 231 and/or 232 may dock to the charging hole(s) associated with (e.g., configured to be covered by) the charging hole cap Cc. The charging apparatus 10 may charge the charging target via the open charging hole. As described herein, the charging process may be automated. Furthermore, convenience of the user may be improved by simultaneously charging a plurality of charging targets over less time.

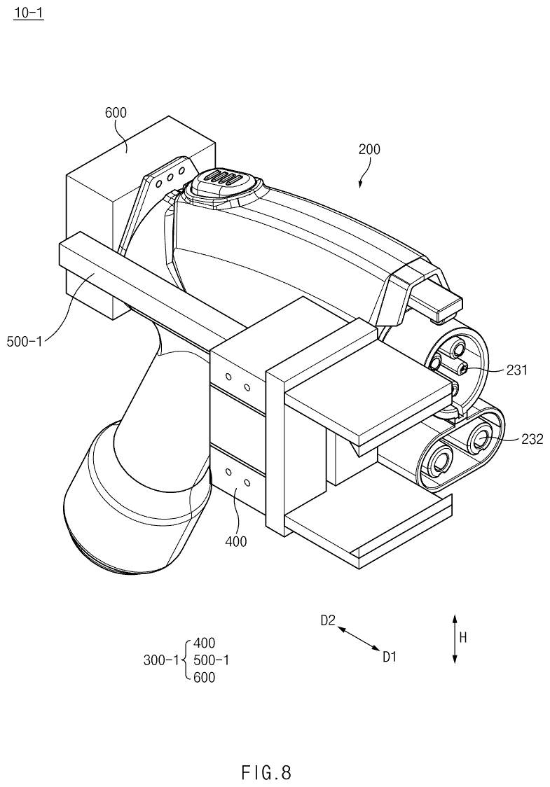

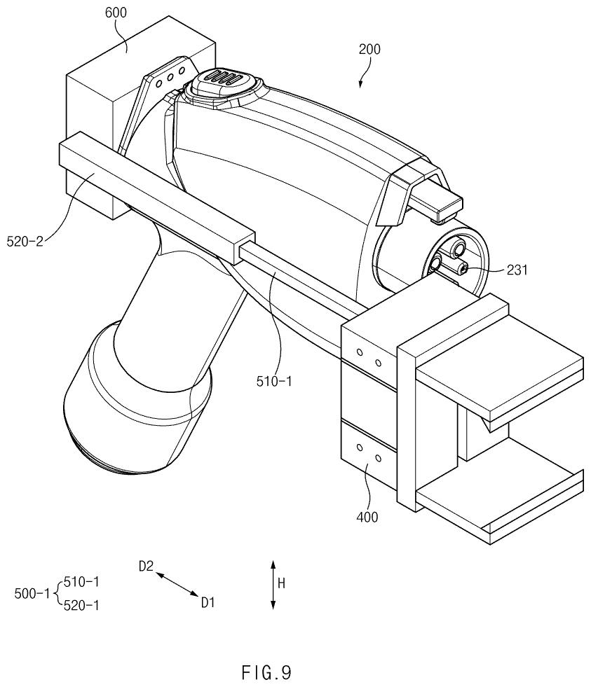

FIG. 8 is a perspective view of a charging apparatus according to another example of the present disclosure. FIG. 9 is a perspective view of a charging apparatus in a state, in which a gripper is moved in a docking direction according to another example of the present disclosure.

Referring to FIGS. 8 and 9, the attachment/detachment part 100, the charging part 200, and the gripper 400 of the charging apparatus 10-1 according to another example of the present disclosure may be configurations corresponding to configurations of the attachment/detachment part 100, the charging part 200, and the gripper 400 of FIGS. 1 to 4. Accordingly, a description of the attachment/detachment part 100, the charging part 200, and the gripper 400 according to another example of the present disclosure is replaced with the description made in FIGS. 1 to 4.

The charging apparatus 10-1 according to another example of the present disclosure may include a charging hole opening/closing part 300-1 having a gripper connecting member 500-1 that is different from the gripper connecting member 500 of the charging apparatus 10 of FIG. 3.

The gripper connecting member 500-1 of the charging hole opening/closing part 300-1 may be formed to be translated in the docking direction D1 or the undocking direction D2.

The gripper connecting member 500-1 may include a first end that is connected to the gripper 400 and a second end, opposite to the first end, that is connected to the driving module 600.

A position of the second end of the gripper connecting member 500-1 may be fixed, and the first end of the gripper connecting member 500-1 may be translated along the docking direction D1 or the undocking direction D2.

If the gripper 400 grips the charging hole cap Cc (see FIG. 3), the gripper connecting member 500-1 may be moved forward to be prolonged in the docking direction D1, and after the gripper 400 grips the charging hole cap Cc, the gripper connecting member 500-1 may be moved rearward to be contracted in the undocking direction D2.

If the gripper connecting member 500-1 is extended in the docking direction D1, as illustrated in FIG. 9, the gripper 400 may be located at a first position in the docking direction D1 relative to the docking areas 231 and 232 (see FIG. 2). Furthermore, if the gripper connecting member 500-1 is retracted in the undocking direction D2, as illustrated in FIG. 8, the gripper 400 may be located at a second position that is located in the undocking direction D2 relative to the docking areas 231 and 232. In this way, the gripper 400 may be translated between the first position and the second position.

The gripper connecting member 500-1 may include a first sliding body 510-1 that is connected to the gripper 400 and extends in the docking direction D1 (e.g., to the first position), and a second sliding body 520-2 that is located in the opposite direction to the docking direction of the first sliding body 510-1 and is configured such that the first sliding body 510-1 is inserted thereinto.

The second sliding body 520-1 may define an accommodation groove for accommodating the first sliding body 510-1 in an interior thereof. If the first sliding body 510-1 is accommodated in the accommodation groove, the gripper connecting member 500-1 may be in a retracted state, and if the first sliding body 510-1 is withdrawn from the accommodation groove, the gripper connecting member 500-1 may be in an extended state.

The charging apparatus 10 may grip the charging hole cap Cc (see FIG. 3) provided in the charging housing Ch and retract the charging hole cap Cc away from the charging hole. The charging apparatus 10 may charge the charging target via the open charging hole, whereby the charging process may be automated. Furthermore, convenience of the user may be improved by simultaneously charging a plurality of charging targets with less time.

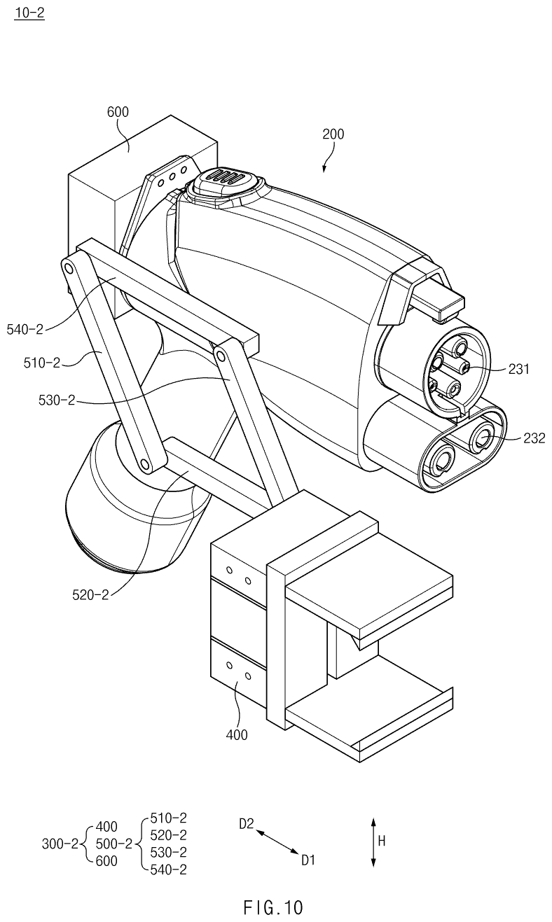

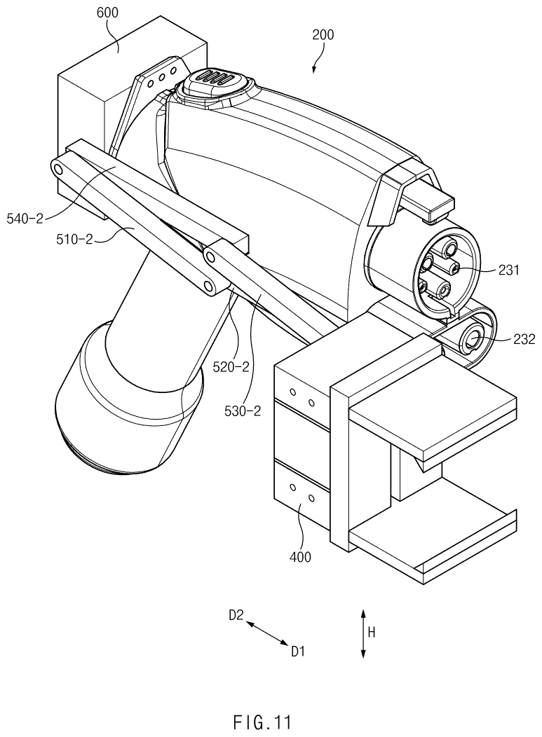

FIG. 10 is a perspective view of a charging apparatus according to another example of the present disclosure. FIG. 11 is a perspective view of a charging apparatus in a state, in which a gripper is moved in a docking direction according to another example of the present disclosure.

Referring to FIGS. 10 and 11, the attachment/detachment part 100, the charging part 200, and the gripper 400 of the charging apparatus 10-2 according to another example of the present disclosure may be configurations corresponding to configurations of the attachment/detachment part 100, the charging part 200, and the gripper 400 of FIGS. 1 to 4. Accordingly, a description of the attachment/detachment part 100, the charging part 200, and the gripper 400 according to another example of the present disclosure is replaced with the description made in FIGS. 1 to 4.

The charging apparatus 10-2 according to another example of the present disclosure may include a charging part opening/closing part 300-2 having a gripper connecting member 500-2 that is different from the gripper connecting member 500 of the charging apparatus 10 of FIG. 3.

The gripper connecting member 500-2 may be provided as a four-part link to move the gripper 400 in the docking direction D1 or the undocking direction D2. The gripper connecting member 500-2 may include a base link 540-2 and first to third links 510-2, 520-2, and 530-2.

The base link 540-2 may include one (e.g., first) end that is fixed to the driving module 600 and an opposite end (e.g., second end) that is fixed to the charging part 200. The first link 510-2 may include one (e.g., first) end connected to the driving module 600 and/or the one end of the base link 540-2, and an opposite (e.g., second) end that is rotatable by the driving module 600.

The second link 520-2 may include one end (e.g., a first end) that is connected to the opposite end of the first link 510-2 and an opposite (e.g., second) end that is rotatable about the first link 510-2. The third link 530-2 may include one (e.g., first) end that is connected to the opposite end of the base link 540-2 and an opposite (e.g., second) end that is connected to the opposite end of the second link 520-2. The opposite end of the second link 520-2 and the opposite end of the third link 530-2 may be connected to the gripper 400.

A motor (not illustrated) for rotating the first link 510-2, a connection shaft (not illustrated) for connecting the motor and the first link 510-2, and a stopper (not illustrated) for preventing the connection shaft or the first link 510-2 from being rotated a specific angle or more may be provided (e.g., in an interior of the driving module 600).

As an example, the stopper may be provided on the connection shaft so as to interfere with the first link 510-2, or may be provided adjacent to the connection shaft to interfere with the connection shaft. The stopper may restrict the connection shaft and/or the first link 510-2 from rotating outside of a specific rotation range. For example, the first link 510-2 may be prevented from being rotated by a specific angle or more in a clockwise or counterclockwise direction.

If the motor of the driving module 600 is driven, the opposite end of the first link 510-2 may be rotated in a clockwise and/or counterclockwise direction with respect to the one end of the first link 510-2. Furthermore, because the one end of the second link 520-2 is coupled to the opposite end of the first link 510-2, the second link 520-2 may also be rotated along the first link 510-2.

Due to this structure, if the opposite end of the first link 510-2 is rotated counterclockwise with respect to the one end of the first link 510-2, the gripper 400 may be located in (e.g., moved to) the docking direction D1 relative to the docking areas 231 and 232, and if the opposite end of the first link 510-2 is rotated clockwise with respect to the one end of the first link 510-2, the gripper 400 may be located in the undocking direction D2.

Even with this structure, because the gripper 400 may be moved between (e.g., from) the first position, which is located in the docking direction D1 relative to the docking areas 231 and 232, and (e.g., to) the second position, which is located in the undocking direction D2 relative to the docking areas 231 and 232, the charging apparatus 10-2 may grip the charging hole cap Cc (see FIG. 3) and separate it from the charging hole (e.g., move the charging hole cap Cc to the second position, away from the charging hole), whereby the charging target may be easily charged.

Accordingly, the charging apparatus 10-2 may grip the charging hole cap Cc provided in the charging housing Ch, remove the charging hole cap Cc and move out of the way of the docking areas 231 and 232, and charge the charging target via the open charging hole (e.g., one or more open/exposed charging holes). The charging process may be automated. Furthermore, convenience of the user may be improved by simultaneously charging a plurality of charging targets over less time.

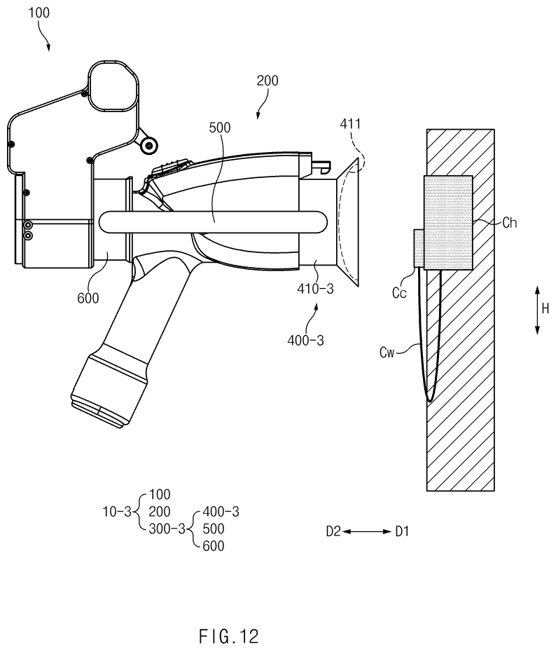

FIG. 12 is a side view of a charging apparatus according to another example of the present disclosure.

Referring to FIG. 12, the charging apparatus 10-3 according to another example of the present disclosure may include a charging hole opening/closing part 300-3 having a gripper 400-3 that is different in shape from the gripper 400 of the charging apparatus 10 illustrated in FIG. 3.

The gripper 400-3 may include a supporting body 410-3 that is coupled to the gripper connecting member 500.

The supporting body 410-3 may include a recessed area 411 that has a shape that is opened toward the docking direction D1 to be attached to the charging hole cap Cc. The shape may be recessed in the undocking direction D2.

The gripper 400-3 may grip the charging hole cap Cc via suction.

When the charging hole cap Cc is closely attached to the recessed area 411, the charging hole cap Cc may be pulled away from the charging housing Ch by the gripper 400-3 to open the charging hole (e.g., one or more charging holes). The charging hole cap Cc may be replaced in the charging hole, and the charging hole cap Cc may be separated from the recessed area 411 (e.g., if the charging hole cap Cc is released from the recessed area 411/released from the suction), and the gripper 400-3 may be moved away from the charging hole, leaving the charging hole closed.

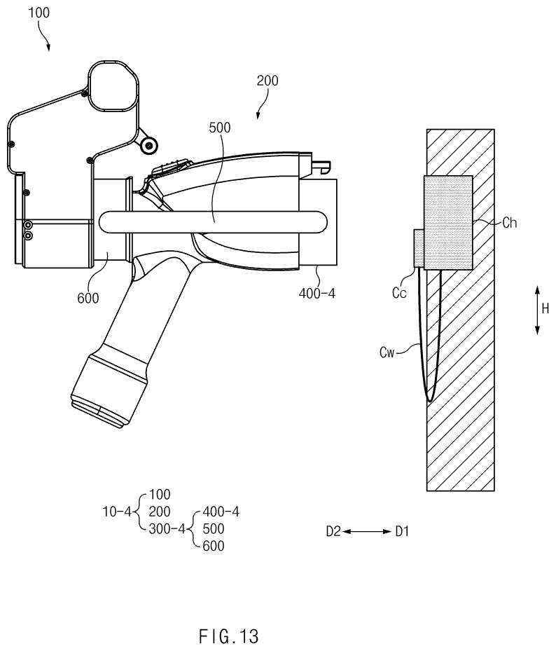

FIG. 13 is a side view of a charging apparatus according to another example of the present disclosure.

Referring to FIG. 13, the charging apparatus 10-4 according to another example of the present disclosure may include a charging hole opening/closing part 300-4 having a gripper 400-4 that is different in shape from the gripper 400 of the charging apparatus 10 illustrated in FIG. 3.

The gripper 400-4 may include a magnet that may attract or push the charging hole cap Cc by a magnetic force. For example, the gripper 400-4 may be provided with a magnet oriented to have a first pole in the docking direction D1. The charging hole cap Cc may comprise a magnet oriented to have a second pole in the undocking direction D2 (e.g., facing the gripper 400-4 when the gripper approaches the charging hole cap Cc. The first pole may a same polarity as the second pole, or a different pole therefrom. The magnetic polarity of the first pole and/or the second pole may be controllable (e.g., able to be switched and/or turned on/off).

The gripper 400-4 may grip the charging hole cap Cc by magnetic force.

If the first pole a different polarity from the second pole, the charging hole cap Cc may be moved from the charging housing Ch to the gripper 400-4 by attraction between the first and second poles. Thus, the charging hole may be opened. The charging hole cap Cc may be replaced in the charging hole, and, if the first pole is the same polarity as second hole, and/or if the first or second pole is turned off, the charging hole cap Cc may be released from the gripper 400-4 so the charging hole may be closed.

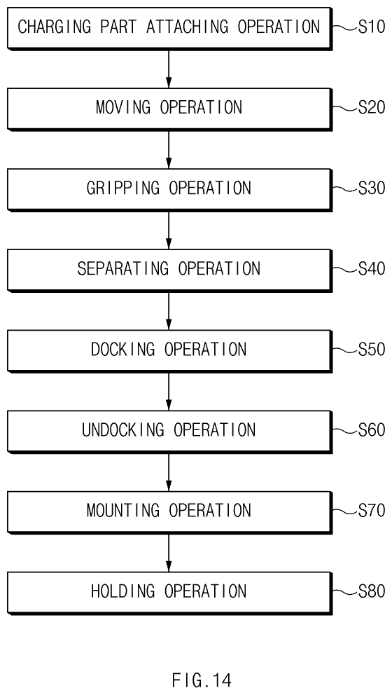

FIG. 14 is a flowchart of a charging method according to an example of the present disclosure. The method of charging the charging target by using one or more of the charging apparatuses 10, 10-1, 10-2, 10-3, and 10-4 will be described with reference to FIGS. 3 to 14.

The charging method according to an example of the present disclosure may include a charging part attaching operation S10, a moving operation S20, a gripping operation S30, a separating operation S40, a docking operation S50, an undocking operation S60, a mounting operation S70, and a holding operation S80.

The charging part attachment operation S10 may include the attachment/detachment part 100 approaching the charging part 200, which may be held on the holder St and attaching the charging part 200 to the attachment/detachment part 100.

The moving operation S20 may be an operation of moving the charging part 200 to/towards the charging hole together with the attachment/detachment part 100 (e.g., after the charging part attachment operation S10).

The gripping operation S30 may be an operation of the grippers (e.g., 400, 400-3, and/or 400-4) provided on the docking direction D1 of the charging part 200 gripping the charging hole cap Cc after the moving operation S20.

In the gripping operation S30, as illustrated in FIG. 5, the first grip finger 420 and the second grip finger 430 may be moved to become closer to each other so that the first grip finger 420 and the second grip finger 430 together grip the charging hole cap Cc. In another example, gripper 400-3 may apply suction. In another example, gripper 400-4 may apply a magnetic force.

The separating operation S40 may be an operation of the grippers (e.g., 400, 400-3, and/or 400-4) separating the charging hole cap Cc from the charging hole after the gripping operation S30 (e.g., the grippers may move away from the charging housing Ch while gripping the charging hole cap Cc).

The separating operation S40 may include the grippers (e.g., 400, 400-3, and 400-4) that grip the charging hole cap Cc in the gripping operation S30 becoming more distant from the docking areas 231 and 232 (e.g., in the docking direction D1).

The separating operation S40 may include the grippers (e.g., 400, 400-3, and/or 400-4), gripping the charging hole cap Cc and being/moving to be separated from the charging part 200, such as being rotated about a central axis that extends perpendicular to the docking/undocking directions (D1/D2) about the opposite end of the gripper connecting member 500 or being translated along the docking direction D1/undocking direction D2 according to the examples described herein.

Furthermore, the separating operation S40 may include moving the grippers 400, 400-3, and 400-4 that grip the charging hole cap Cc in the gripping operation S30 in a combination of rotational and translational movements.

The docking operation S50 may be an operation of the charging part 200 being docked to the charging hole (e.g., after/based on the separating operation S40). In this process, the charging part 200 may be electrically connected to the charging hole (e.g., one or more charging holes made available/exposed by removing of the charging hole cap Cc) and the charging target may be charged via the charging part 200.

The attachment/detachment part 100 may be detached from the charging part 200 and/or attached to another charging part 200 to dock the other charging part 200 to a different charging target.

The undocking operation S60 may be an operation of the attachment/detachment part 100 being re-mounted on the charging part 200 (if it detached from the charging part 200) that is electrically connected to the charging target. The undocking operation S60 may be performed based on/after charging has been completed. The charging part 200 may be moved away/more distant from the charging hole than in the docking operation S50. In the undocking operation S60, the charging part 200 may be moved in the undocking direction D2.

The mounting operation S70 may be an operation of the grippers (e.g., 400, 400-3, and/or 400-4), gripping the charging hole cap Cc from the gripping operation S30, mounting the charging hole cap Cc back to the charging hole after the undocking operation S60.

If the grippers (e.g., 400, 400-3, and/or 400-4) mounted on the docking areas 231 and 232, are moved away from the docking areas 231 and 232 while gripping the charging hole cap Cc in the separating operation S40, the charging hole cap Cc may be gripped and/or may be moved in the docking direction D1 relative to the docking areas 231 and 232 in the mounting operation S70. Furthermore, the grippers (e.g., 400, 400-3, and/or 400-4) may place the charging hole cap Cc to re-mount the charging hole cap Cc on the charging housing Ch (e.g., to cover the charging hole and/or the one or more charging holes) in the mounting operation S70.

The holding operation S80 may be an operation of the attachment/detachment part 100 replacing the charging part 200 on the holder St after the mounting operation S70.

Thereafter, the attachment/detachment part 100 may be detached from the charging part 200 and may be mounted on/attached to another charging part 200.

According to the above-described charging method, a plurality of charging targets may be automatically charged by a plurality of charging parts 200, and a waiting time for a plurality of charging targets to be charged may be reduced, and thus, convenience of the user may be improved.

The present disclosure has been made to solve the problems occurring in the prior art while advantages achieved by the prior art are maintained intact.

An aspect of the present disclosure provides a charging apparatus that may automate and unman charging processes by mounting or separating a charging hole cap.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a charging apparatus includes a charging part including a docking area configured to dock to a charging hole, and a charging hole opening/closing part configured to be mounted on the charging part, and the charging hole opening/closing part may include a gripper provided on one side of the docking area, which faces the charging hole, to grip a charging hole cap configured to cover the charging hole, and a gripper connecting member coupled to the gripper, and configured such that the gripper is movable in a direction being more distant from the docking area.

The gripper may include a supporting body coupled to the gripper connecting member, and a grip finger protruding from the supporting body in an extension direction of the gripper connecting member, and configured to grip the charging hole cap on the one side of the docking area.

The grip finger may include a first grip finger and a second grip finger configured to be movable in a direction, in which the first grip finger and the second grip finger becomes closer to each other, and a direction, in which the first grip finger and the second grip finger becomes more distant from each other.

The first grip finger may include a first connection area protruding from the supporting body, and a first grip area protruding from one end of the first connection area toward the second grip finger, and the second grip finger may include a second connection area protruding from the supporting body in parallel to the first connection area, and a second grip area protruding from one end of the second connection area toward the first grip finger.

The gripper connecting member may include one end connected to the gripper, and he one end of the gripper connecting member may be configured to be rotated about a rotation axis extending in a direction crossing a docking direction being a direction, in which the docking area is docked to the charging hole.

When the docking direction is a forward direction, the one end of the gripper connecting member may be configured to be rotated about a rotation axis extending in a leftward/rightward direction.

The gripper connecting member may further include an opposite end formed on an opposite side to one side, on which the one end of the gripper connecting member is provided, and the one end of the gripper connecting member may be configured to be rotated about the opposite end.

The gripper connecting member may include one end connected to the gripper, and the one end of the gripper connecting member may be formed to be translated along a docking direction, in which the one end is docked to the charging hole.

The gripper may be translated between a first position, in which the gripper is located in the docking direction of the docking area, and a second position, in which the gripper is located in an opposite direction to the docking direction of the docking area.

The gripper connecting member may include a first sliding body connected to the gripper, and a second sliding body located in an opposite direction of the docking direction of the first sliding body, and configured such that the first sliding body is inserted.

The charging hole opening/closing part may further include a driving module configured to rotate the gripper connecting member, and located in an opposite direction to a direction, in which the docking area of the charging part is docked to the charging hole, and the gripper connecting member may include a base link including one end fixed to the driving module, and an opposite end fixed to the charging part, a first link including one end connected to the driving module and the one end of the base link, and an opposite end being rotatable by the driving module, a second link including one end connected to the opposite end of the first link, and an opposite end being rotatable about the first link, and a third link including one end connected to the opposite end of the base link, and an opposite end connected to the opposite end of the second link.

The opposite end of the second link may be connected to the gripper.

The gripper may include a recessed area having a shape opened to the one side to be attached to the charging hole cap, and having a shape recessed in an opposite direction to the one side.

The gripper may include a magnet.

According to another aspect of the present disclosure, a charging method includes a moving operation of moving a charging part to a charging hole, a gripping operation of gripping a charging hole cap configured such that a gripper provided on one side of the charging part, which faces the charging hole, covers the charging hole, a separating operation of, by the gripper, separating the charging hole cap from the charging hole, and a docking operation of docking the charging part to the charging hole.

The separating operation may include moving the gripper gripping the charging hole cap in the gripping operation in a direction being more distant from the charging part.

When a direction, in which the charging part is docked to the charging hole, is defined as a docking direction, the separating operation may include separating the gripper gripping the charging hole cap in the gripping operation from the charging part to rotate the gripper about a central axis extending in a direction crossing the docking direction or translating the gripper along the docking direction.

The charging method may further include an undocking operation of moving the charging part in a direction being more distant from the charging hole, after the docking operation.

The charging method may further include a mounting operation of, by the gripper gripping the charging hole cap in the gripping operation, mounting the charging hole cap on the charging hole, after the undocking operation.

The charging method may further include a holding operation of holding the charging part on a holder, after the mounting operation.

In this technology, because the gripper may grip the charging hole cap and separate it from the charging hole, the charging target may be charged in an automated and unmanned manner, and thus, convenience of the user may be improved.

In addition, various effects directly or indirectly identified through this document may be provided.

The above description is a simple exemplary description of the technical spirits of the present disclosure, and an ordinary person in the art, to which the present disclosure pertains, may make various corrections and modifications without departing from the essential characteristics of the present disclosure.

Therefore, the examples disclosed in the present disclosure are not for limiting the technical spirits of the present disclosure but for describing them, and the scope of the technical spirits of the present disclosure is not limited by the examples. The protection scope of the present disclosure should be construed by the following claims, and all the technical spirits in the equivalent range should be construed as being included in the scope of the present disclosure.

What is claimed is:

1. A charging apparatus comprising:
a charging part comprising one or more electrical plugs configured to dock to one or more charging holes; and
a charging hole opening/closing part mounted on the charging part,
wherein the charging hole opening/closing part comprises:
a gripper configured to:
be positioned on a docking side of the one or more electric plugs, wherein the docking side is a side that faces the one or more charging holes when docking; and
grip a charging hole cap configured to cover the one or more charging holes; and
a gripper connecting member, coupling to the gripper to the charging part, configured to move the gripper from the docking side of the one or more electric plugs to be positioned away from the docking side of the one or more electric plugs.

2. The charging apparatus of claim 1, wherein the gripper comprises:
a supporting body coupled to the gripper connecting member; and
grip fingers, protruding from the supporting body in a direction configured to point away from the docking side when the gripper is positioned on the docking side, configured to grip the charging hole cap.

3. The charging apparatus of claim 2, wherein the grip fingers comprise a first grip finger and a second grip finger, wherein the first grip finger and the second grip finger are configured move towards each other, or away from each other.

4. The charging apparatus of claim 3, wherein the first grip finger comprises a first connection portion protruding from the supporting body, and a first grip portion protruding, from an end of the first connection portion away from the supporting body, toward the second grip finger, and
wherein the second grip finger comprises a second connection portion protruding from the supporting body parallel to the first connection portion, and a second grip portion protruding, from an end of the second connection portion away from the supporting body, toward the first grip finger.

5. The charging apparatus of claim 1, wherein the gripper connecting member comprises a first end connected to the gripper, and
wherein the first end of the gripper connecting member is configured to be rotated about a rotation axis extending in a direction perpendicular to a docking direction in which the one or more electric plugs are configured to dock to the one or more charging holes.

6. The charging apparatus of claim 5, wherein if the docking direction is a horizontal direction,
the first end of the gripper connecting member is configured to be rotated about a rotation axis extending in a second horizontal direction.

7. The charging apparatus of claim 5, wherein the gripper connecting member further comprises a second end, opposite to the first end, rotationally connected to the charging part so as to allow rotation of the first end.

8. The charging apparatus of claim 1, wherein the gripper connecting member comprises a first end connected to the gripper, and
wherein the first end of the gripper connecting member is configured to be translated along a docking direction in which the one or more electric plugs are configured to dock to the one or more charging holes.

9. The charging apparatus of claim 8, wherein the gripper is configured to be translated, via the gripper connecting member, between a first position, in which the gripper is located in the docking direction relative to the one or more electric plugs, and a second position, in which the gripper is located in an opposite direction to the docking direction relative to the one or more electric plugs.

10. The charging apparatus of claim 8, wherein the gripper connecting member comprises:
a first sliding body connected to the gripper; and
a second sliding body, connected to the charging part, located in an opposite direction to the docking direction relative to the first sliding body, and forming a groove configured to accommodate insertion of the first sliding body.

11. The charging apparatus of claim 1, wherein the charging hole opening/closing part further comprises a driving module, configured to rotate the gripper connecting member, and located on a side of the charging part opposite to the one or more electrical plugs, and
wherein the gripper connecting member comprises:
a base link comprising a first end fixed to the driving module, and a second end fixed to the charging part;
a first link comprising a first end rotatably connected to the first end of the base link, and a second end configured to be rotated, by the driving module, about the first end of the first link;
a second link comprising a first end rotatably connected to the second end of the first link, and a second end rotatable relative to the first link; and
a third link comprising a first end rotatably connected to the second end of the base link, and second end rotatably connected to the second end of the second link.

12. The charging apparatus of claim 11, wherein the second end of the second link is connected to the gripper.

13. The charging apparatus of claim 1, wherein the gripper:
comprises a recessed area having a shape that, when the gripper is positioned on the docking side, opens away from the docking side and is recessed in towards the docking side; and
is configured to attach to the charging hole cap via suction.

14. The charging apparatus of claim 1, wherein the gripper comprises a magnet.

15. An automated charging method comprising:
moving a charging part, comprising one or more electric plugs and a gripper, in a docking direction towards one or more charging holes covered by a charging hole cap;
gripping, via the gripper, the charging hole cap;
separating, by the gripper, the charging hole cap from the one or more charging holes by moving the gripped charging hole cap away from the one or more charging holes; and
docking the one or more electric plugs to the one or more charging holes.

16. The automated charging method of claim 15, further comprising:
moving the gripper gripping the charging hole cap to be farther away from the one or more charging holes than the one or more electric plugs are to the one or more charging holes.

17. The automated charging method of claim 15, further comprising:
separating the gripper, gripping the charging hole cap, from the one or more electric plugs by one or more of:
rotating the gripper about an axis extending in a direction perpendicular to the docking direction; or
translating the gripper along the docking direction away from the one or more charging holes.

18. The automated charging method of claim 15, further comprising:
undocking the one or more electrical plugs from the one or more charging holes by moving the charging part in a direction away from the one or more charging holes.

19. The automated charging method of claim 18, further comprising:
mounting, after the undocking and by the gripper gripping the charging hole cap, the charging hole cap on the one or more charging holes; and
releasing, by the gripper, the charging hole cap.

20. The automated charging method of claim 19, further comprising:
attaching, by the charging part, to an attachment/detachment part of a robotic arm, wherein the moving the charging part is based on movement of the robotic arm and comprises moving the charging part from a holder, and
replacing, after the releasing the charging hole cap, the charging part on the holder.

21. A charging apparatus comprising:
a charging part comprising:
one or more electrical plugs, facing a docking direction of the charging part, configured to dock to one or more charging holes of a charging target; and
a bracket configured to detachably attach to a robotic arm configured to move the charging part; and
a charging hole opening/closing part, attached to the charging part, comprising:
a gripper configured to grip a charging hole cap configured to cover the one or more charging holes; and
a gripper connecting member configured to:
movably couple the gripper to the charging part; and
move the gripper between a first position in the docking direction relative to the one or more electric plugs and a second position in an opposite direction to the docking direction relative to the one or more electric plugs.
